(19) United States
(12) Patent Application Publication
(10) Pub. No.: US 2003/0154310 A1
(43) Pub. Date: Aug. 14, 2003

(54) Web based satellite system

(75) Inventor: Zvi David, Kfar Saba (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: SATELLITE-SMART SOLUTIONS LTD.

(21) Appl. No.: 10/365,508

(22) Filed: Feb. 13, 2003

Related U.S. Application Data
(60) Provisional application No. 60/355,821, filed on Feb. 13, 2002.

(51) Int. Cl. G06F 15/16

(52) U.S. Cl. 709/249

(57) ABSTRACT

A method and system for supporting communication through a satellite and/or satellite-based network with a remote ground transceiver, through a user interface which is available to the end user through the Internet. The present invention preferably provides such an interface as a Web-based interface, through a Web server. According to a preferred but non-limiting embodiment of the present invention, communication from the remote ground transceivers may optionally include an alarm message and/or other information about the status of the remote ground transceiver and/or associated ground asset.

This Application claims priority from U.S. Provisional Application No. 60/355,821, filed on Feb. 13, 2002, which is hereby incorporated by reference as if fully set forth herein.

### FIELD OF THE INVENTION

The present invention is of a method and a system for communication with a remote ground transceiver through a satellite, and in particular, for such communication through a Web-based interface.

### BACKGROUND OF THE INVENTION

Automated technology has enabled equipment which is located in remote areas to be managed at a management station by commands which can be sent remotely. Such automated technology includes sensors for detecting equipment malfunctions, security mechanisms against theft, and other monitoring devices for ensuring the proper function of the equipment without the presence of a human operator. These monitoring devices must be able to relay their findings to a management station, particularly in the case of an equipment malfunction in which an alum would be required. Transceivers which are based on communication through a satellite are often the best or even the only choice for enabling the remote equipment to communicate with the management station.

Such transceivers operate through wireless communication with the satellite, which then relays the communication to the intended recipient by using an email procedure as is well known in the art, such as Simple Mail Transfer Protocol (SMTP). SMTP is the standard e-mail protocol on the Internet. However, sending such communication to the management system may not be the most useful choice for the end user, who wishes to receive the communication and/or to send a message in reply to the remote ground transceiver. In particular, the end user may not be able to easily access the management system. For example, currently the management system may be installed at a fixed location, such as a call center for example. However, for greater ease of management, the end user should be able to access the management system, and hence be able to communicate with the remote ground transceiver, at substantially any location.

Unfortunately, such flexible, accessible management systems are not currently available, for supporting communication with a remote ground transceiver at substantially any location.

### SUMMARY OF THE INVENTION

The background art does not teach or suggest a flexible, accessible management system for communication through a satellite. The background art also does not teach or suggest such a system for supporting communication with a remote ground transceiver at substantially any location. The background art also does not teach or suggest communication with the remote ground transceiver, and/or any type of remote asset components located at or near the remote ground transceiver, through the Internet.

The present invention overcomes these disadvantages of the background art by providing a method and system for supporting communication through a satellite and/or satellite-based network with a remote ground transceiver for a remote ground asset, through a user interface which is available to the end user though the Internet. The present invention preferably provides such an interface as a Web-based interface, through a Web server. The use of such a Web server has a number of advantages. First, access to the Internet is generally available, such that the present invention enables communication to occur in a generally available manner. Second, such access may be provided through a variety of devices, such as wireless devices, which provide flexible access at a variety of locations, such that the end user can be at substantially any location to which such service can be provided. Also, any changes or information may be given to the Web server, and then provided by access through the Internet.

The present invention may easily be operative at a variety of locations, while using existing Internet-based infrastructure such as the World Wide Web (WWW), which is commonly known as the web.

The present invention optionally and preferably features a system for supporting communication between the satellite and the end user. The system may preferably comprise server applications which reduce the cost and complexity of building, deploying, and managing integrated and scalable information technology (IT) solutions for a communications network. These server applications may comprise one or more of an exchange server, an SQL server, a management server, an Internet security server, and an integration server. The system may preferably provide one or more of remote server administration and monitoring/troubleshooting, diagnostic views and reports, shared modem service, shared fax service, and shared applications.

Communication between the end user and the satellite is also preferably supported by a gateway, which handles communication between the satellite and a server such as the management server for example.

The management server preferably communicates with the satellite gateway according to a network connection, such as a regular Internet connection. The management server may also optionally be connected directly to the satellite gateway, although such a configuration is not preferred. The end user computer and/or operator terminal is optionally and more preferably connected to the management server through a network connection, which is most preferably a Web server and/or other type of Web-based connection.

If the management server is implemented with or according to a Web server, for example, the end user may optionally access information through a Web page and/or other type of Web-based interface. The Web server typically has a domain name system (DNS) number, such that any end user having the Web address (URL, also known as uniform resource locator or universal resource locator) can optionally access the Web page. Preferably, an identifier such as a password and user name is required for access. Thus, the end user may optionally communicate with the remote ground transceiver, for example in order to control the actions of the remote ground asset connected to the transceiver, such as a vehicle, through the Web-based interface, preferably without requiring any additional software or other installed components.

Other examples of suitable applications include but are not limited to, anti-theft, safety and security, mail, content related to remote ground asset location such as specific weather reports, providing directions to the operator of the remote ground asset diagnostics, command and control, and also controlling functions of the asset itself, such as honing off the engine, locking the door and so forth.

Also, any required information or data, such as maps for example, may be provided from the Web server through the Internet, to any location which is accessible via the Internet.

The present invention is suitable for use with any remote ground transceiver which is able to communicate with a satellite and/or satellite-based network. According to a non-limiting, optional but typical embodiment, such transceivers operate through wireless communication with the satellite, which then relays the communication to the intended recipient, such as the management system for example. The end user then accesses the communication from the management server through the Web-based user interface.

According to a preferred but non-limiting embodiment of the present invention, the communication may optionally include an alarm message and/or other information about the status of the remote ground transceiver and/or associated ground asset.

In preferred embodiments of the present invention, two remote ground assets may preferably communicate directly to each other. Therefore, one remote ground asset can optionally be in communication with another remote ground asset, instead of (or in addition to) the end user. A similar system as above could be used, except that the first remote ground transceiver is in communication with the satellite. The satellite is in communication with the gateway. The second remote ground asset would also be in communication with the gateway through the satellite. Optionally and preferably, the communication would actually be routed through the management server. For example, this methodology would enable two boats in a fleet to communicate with each other.

In other alternative preferred embodiments, one remote asset can optionally and preferably broadcast to a number of addresses. For example, remote asset A can talk to remote asset B, as well as to the end user such as a fleet manager or call center or any other end user, and/or to other locations at the same time.

The message can therefore optionally be sent to several locations at the same time, which is very convenient and also is useful with respect to bandwidth.

There is thus provided in accordance with a preferred embodiment of the present invention, a system for enabling communication with a remote ground asset by an end user through a satellite, including a transceiver at the remote ground asset, wherein the transceiver is capable of communication with the satellite, a gateway for communicating with the transceiver through the satellite, a management server for providing at least one Web page for the communication, and an end user device for displaying the at least one Web page to the end user.

There is also provided in accordance with another preferred embodiment of the present invention, a method for enabling communication with a remote ground asset by an end user through a satellite, including receiving information through the satellite from die remote ground asset, displaying the information to the end user as a Web-based interface, receiving at least one command from the end user through the Web-based interface, and transmitting the at least one command to the remote ground asset through the satellite.

### BRIEF DESCRIPTION OF THE DRAWINGS

The invention is herein described, by way of example only, with reference to the accompanying drawings, wherein:

FIG. 1 is a schematic block diagram showing an exemplary system according to the present invention;

FIG. 2 is a preferred embodiment of an implementation of the system architecture of the present invention;

FIG. 3 shows a schematic block diagram of exemplary components, which may optionally be used with the exemplary system of FIG. 1 according to the present invention;

FIG. 4 illustrates a method for processing messages which are generated at the remote ground asset;

FIG. 5 illustrates a method for processing messages which are generated at the end user;

FIG. 6 shows an exemplary graphical user interface (GUI) provided to the end user demonstrating what is happening at the remote asset in an implementation of the present invention;

FIG. 7 shows an example of a GUI comprising a map with landmarks provided to the end user for the tracking of assets in an implementation of the present invention; and

FIG. 8 shows an example of a GUI comprising a command sent from the end user to the remote ground asset in an implementation of the present invention.

### DESCRIPTION OF THE PREFERRED EMBODIMENTS

The present invention is of a method and system for supporting communication through a satellite and/or satellite-based network with a remote ground transceiver, through a user interface which is available to the end user through the Internet. The present invention preferably provides such an interface ass a Web-based interface, through a Web server. According to a preferred but non-limiting embodiment of the present invention, communication from the remote ground transceiver may optionally include an alarm message and/or other information about the status of the remote ground transceiver and/or associated remote ground asset. It should be noted that the word “ground” when used for such terms as “remote ground asset” and “remote ground transceiver” is intended only to distinguish the location of the “ground” component from the location of the satellite; the “ground” component does not need to be literally anchored or located in or on the ground, and may even optionally be airborne and/or located on and/or in a body of water, for example.

The present invention optionally and preferably features a back office system, for supporting communication between the satellite and the end user. The back office system is more preferably divided into a server and operator terminal. The server is preferably connected to the gateway which communicates with the satellite according to a network connection, such as a regular Internet connection. The server may also optionally be connected directly to the satellite gateway. The operator terminal is optionally and more preferably connected to the server through a network connection, which is most preferably a Web server and/or other type of Web-based connection.

If the server is implemented with or according to a Web server, for example, the end user may optionally access information through a Web page and/or other type of Web-based interface. The Web server typically has a DNS number, such that any end user having the Web address (URL) can optionally access the Web page. Preferably, an identifier such as a password and user name, for example, is required for access. The web page preferably displays information to the end user about the remote ground asset with location and maps. Thus, the end user may optionally communicate with the remote ground transceiver, for example in order to control the actions of the asset connected to the transceiver and/or to receive information about the location of that transceiver, through the Web-based interface, preferably without requiring any additional software or other installed components. In preferred embodiments of the present invention, the web page comprises at least one diagnostic component for performing a test on at least one function and/or component of the remote ground asset.

According to preferred embodiments of the present invention, a gateway is provided for communicating with the satellite. A mail server is preferably also present, for example for handling e-mail messages, such that the gateway optionally and preferably communicates with the management server through the mail server.

The present invention is suitable for use with any remote ground transceiver which is able to communicate with a satellite and/or satellite-based network. According to a non-limiting, optional but typical embodiment, such transceivers operate through wireless communication with the satellite, which then relays the communication to the intended recipient, for example the management system. The end user then accesses the communication from the management system through the Web-based user interface.

The transceivers communicate with the satellite according to a satellite communications protocol, but from the gateway to the server, any type of network including wireless, wired, and Internet may preferably be used.

The principles and operation of a method and a system according to the present invention may be better understood with reference to the drawings and the accompanying description.

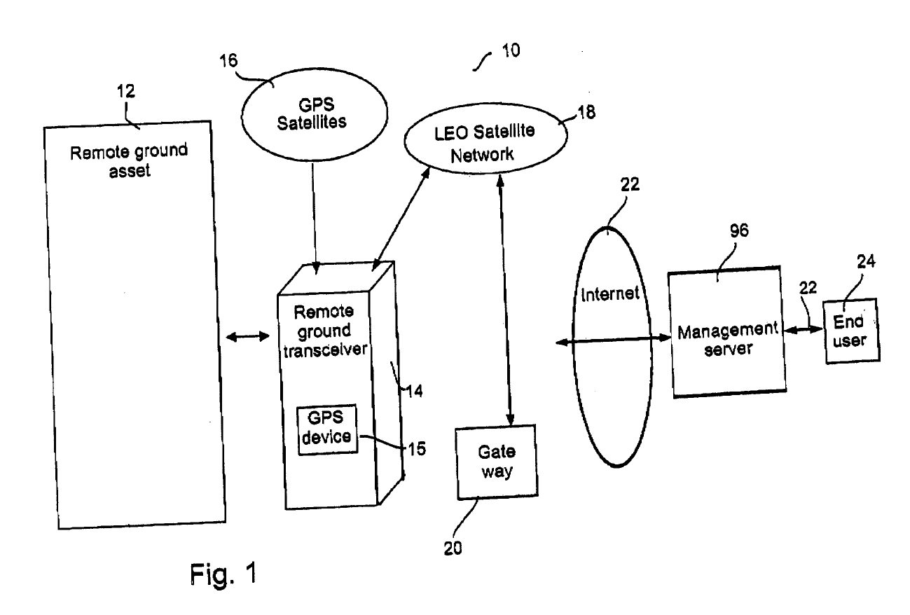

Referring now to the drawings, FIG. 1 demonstrates a schematic block diagram showing an exemplary system according to the present invention. FIG. 1 shows an exemplary system 10 according to the present invention for Web-based communication with the end user. As shown, a remote ground asset 12, for example a vehicle for the purposes of description only and without any intention of being limiting, is in communication with a remote ground transceiver 14. For example remote ground asset 12 may comprise a boat, an automotive vehicle, a stationary object or any other appropriate asset. Remote ground transceiver 14 is optionally in communication with a GPS satellite 16. A GPS device 15 is preferably located at remote ground transceiver 14. Remote ground transceiver 14 is preferably in communication with a satellite, preferably a LEO (low earth orbit) satellite, shown as a LEO satellite network 18 for the purposes of description only and without any intention of being limiting. In other alternative preferred embodiments of the present invention the satellite may comprise a Geosynchronous Earth Orbit (GEO) satellite network. Any other suitable satellite network may also optionally be used in place of, or in addition to, LEO satellite network 18. The operation of these components of exemplary system 10 may be performed according to mechanisms which are well known in the an and which could easily be selected by one of ordinary skill in the art.

LEO satellite network 18 is in communication with a gateway 20 and a management server 96, which again may optionally be implemented according to mechanisms which are well known in the ark such as an Internet 22.

Gateway 20 optionally and more preferably is operatively associated with a management server 96. As described in greater detail below, information is transmitted through remote ground transceiver 14 to LEO satellite network 18, which is more preferably implemented as a satellite network. LEO satellite network 18 then optionally and preferably communicates with gateway 20. Management server 96 preferably receives the data communicated through LEO satellite network 18 from gateway 20, more preferably by pulling the data from gateway 20, but optionally receiving the data through a “push” mechanism, such as an e-mail message being sent from gateway 20. Management server 96 may preferably comprise a Web server and is also more preferably connected to the Internet 22, although management server 96 could alternatively be connected to any type of network. This connection preferably enables management server 96 to provide a plurality of different services, such as back office services to a variety of end users 24. Back office services may preferably reduce the cost and complexity of building, deploying, and managing integrated and scalable information technology (IT) solutions for a communications network.

Back office services may preferably comprise one or more of remote server administration and monitoring/troubleshooting, diagnostic status views and reports, shared modem service, shared fax service, and shared applications.

End users 24 which can operate the present invention optionally comprise a call center, a fleet manager, a dealer and an individual user. This is by way of example only and is not meant to be limiting. Additional or different end users 24 may also optionally operate the present invention. End users 24 are preferably connected to management server 96 through Internet 22, or alternatively may be connected through any suitable network.

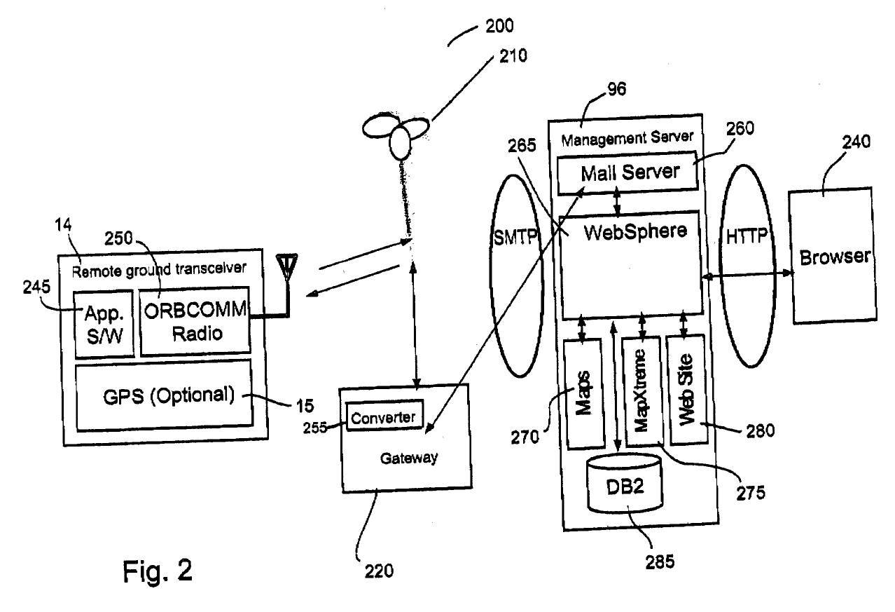

Reference is now made to FIG. 2, which is a preferred embodiment of an implementation of the system architecture of the present invention.

FIG. 2 demonstrates a system 200, which preferably comprises remote ground transceiver 14, a LEO satellite, for example an ORBCOMM™ LEO satellite 210, an ORBCOMM™ gateway 220 (in place of gateway 20), management server 96, and a Web browser 240. It should be noted that although reference is made to the ORBCOMM™ LEO satellite 210, ORBCOMM™ gateway 220 and so forth, this is for the purposes of description only and is not meant to be limiting in any way. Any type of LEO satellite systems or even any other suitable type of satellite system, such as the GEO satellite system for example, could optionally be used in place of, in addition to, or in combination with, the ORBCOMM™ LEO satellite system.

Remote ground transceiver 14 preferably further comprises a GPS device 15, application software 245, and an ORBCOMM™ radio 250. GPS device 15 may optionally be configured as a NMEA0183 serial communication port. GPS device 15 is optional but preferred; certain types of applications at remote ground transceiver 14 do not require knowledge of the location of remote ground transceiver 14, such as command and control functions for operating within remote ground transceiver 14. Alternatively, GPS device 15 may optionally not be required for embodiments of the present invention in which the location of remote ground transceiver 14 may be fixed, for example for stationary assets such as oil pumps and other types of installations that cannot be readily moved. Application software 245 preferably comprises software which controls functionality at remote ground transceiver 14. Application software 245 could preferably comprise software for running at least one alarm in an alarm system or at least one sensor in a sensor system.

Remote ground transceiver 14 preferably communicates through ORBCOMM™ radio 250, for example an ORBCOMM™ two-way Radio, with ORBCOMM™ satellite 210. For example, and without any intention of being limiting, the communications up channel (from ORBCOMM™ radio 250 to ORBCOMM™ satellite 210) may comprise 2400 bps at 148-150 MHz and the communications down channel (from ORBCOMM™ satellite 210 to ORBCOMM™ radio 250) may comprise 4800 bps at 137-138 MHz ORBCOMM™ satellite 210 is in communication with ORBCOMM™ gateway 220. Different speeds and/or frequencies may also optionally be used, in place of or in addition to, the above exemplary, non-limiting speeds and frequencies.

ORBCOMM™ gateway 220 preferably comprises a converter 255 which converts incoming signals from ORBCOMM™ satellite 210 into standard format email data, for example and without intention of being limiting, data formatted according to SMTP.

Management server 96 preferably comprises a mail server 260, an IBM Websphere™ application 265, at least one of a plurality of maps 270 which may optionally and preferably be Web based, a MapXtreme™ software application 275, a Web Site 280, and a database 285. IBM Websphere™ application 265 is a non-limiting but preferred example of an application which acts as a platform for Web-based functionality and other types of communication functionality through a computer network, as well as with mobile devices of various kinds and could optionally be replaced with any other suitable application and/or server. The platform also optionally and preferably supports transaction processing, secure messaging, and so forth.

Mail server 260 preferably pulls data from ORBCOMM™ gateway 220, similar to an IP based operation, the difference being that data is pulled instead of pushed, as in conventional systems as is well known in the art. Because the data is “pulled”, ORBCOMM™ gateway 220 preferably does not need to email data to management server 96.

In an alternative embodiment of the present invention, a mail server located in ORBCOMM™ gateway 220 (not shown) could optionally convert the data to e-mail message(s), and e-mail data to management server 96.

Mail server 260 preferably sends data to IBM Websphere™ application 265 which displays maps on a web interface in conjunction with given business logic. IBM Websphere™ application 265 works in conjunction with MapXtreme™ software application 275, which converts coordinates of specific points of interest including at least one remote ground asset into locations on at least one of a plurality of maps 270 which is displayed on the Web browser 240.

GPS data is preferably provided from GPS device 15 of remote ground transceiver 14 which supplies coordinates to MapXtreme™ software application 275 which are then converted to locations on at least one of a plurality of maps 270.

Database 285 supplies information and coordinates of landmarks which are added to at least one of a plurality of maps 270 by MapXtreme™ software application 275.

IBM Websphere™ application 265 coordinates the construction of data which is transmitted via HyperText Transport Protocol (HTTP) to web browser 240 and displays at least one of a plurality of maps 270. A user (not shown) can view at least one of a plurality of maps 270 through web browser 240. In addition to receiving data, the user can also send data transmitted via HTTP (as user data) back to IBM Websphere™ application 265. Mail server 260 may preferably pull user data from IBM Websphere™ application 265 and send user data back to ORBCOMM™ gateway 220 which sends user data to ORBCOMM™ LEO satellite 210 which sends user data back to remote ground transceiver 14.

In preferred embodiments of the present invention, user data can preferably remotely control any functionality that could be manually controlled onsite at remote ground asset 12 (not shown) through remote ground transceiver 14, non-limiting examples of which are given as follows. User data can instruct an application for controlling a sensor at remote ground asset 12 to take another reading. User data can instruct an alarm to go off. User data can cause the locking of a door. User device can tarn a component at remote ground asset 12 or remote ground asset 12 itself on or off. User data preferably comprises data which is recognized by application software 245. Of course, it should be noted that these are non-limiting examples of controllable functions.

In preferred embodiments of the present invention, management server 96 may preferably comprise a distributed server. For example, and without any intention of being limiting, some combination or subcombination of mail server 260, IBM Websphere™ application 265, at least one of a plurality of maps 270, MapXtreme™ software application 275, Web Site 280, and database 285 may optionally be located on different computers which are in communication with each other to comprise management server 96. Management server 96 optionally and preferably also comprises Geographic Information Systems (&IS) software, for generating one or more maps.

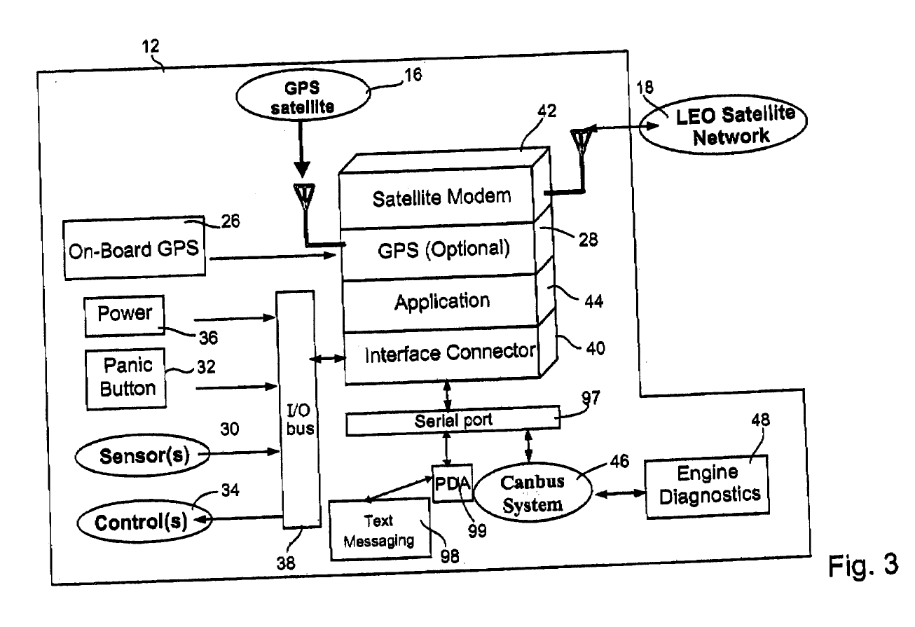

FIG. 3 shows a schematic block diagram of exemplary components, which may optionally be used with tee exemplary system FIG. 1 according to the present invention. As shown, remote ground asset 12 may optionally feature a plurality of components for communicating with LEO satellite network 18 and hence gateway 20 (not shown in FIG. 3). For example, remote ground asset 12 may optionally comprise an on-board GPS device 26, for communicating with an optional GPS transceiver 28 and hence with GPS satellite 16. In any case, the location of remote ground asset 12 is preferably determinable according to some mechanism as GPS for example, and may then be optionally and preferably transmitted through LEO satellite network 18 to gateway 20.

Preferably, a plurality of alarm components is provided, for being able to transmit an alarm through LEO satellite network 18. For example, at least one sensor 30 is optionally and preferably provided, for being able to sense an alarm condition and/or provide other information. A “panic” or alarm button 32 is also preferably provided, for manually initiating an alarm, which may also optionally be connected to some mechanism for determining the location of remote ground asset 12 as previously described. At least one control 34 may also be provided, for being able to control one or more functions of remote ground asset 12, and/or for performing one or more commands on remote ground asset 12. These components are optionally and preferably powered by a power source 36, and preferably communicate through an input/output bus 38.

Input/output bus 38 is preferably in communication with an interface connector 40, for communicating through a satellite modem 42. Interface connector 40 is optionally and preferably suitable for communicating with the other components at remote ground asset 12. Illustrative examples of interface connector 40 include but are not limited to, serial or parallel interfaces. Non-limiting examples of serial electronic interfaces optionally include RS232, RS485, Canbus and others. Interface connector 40 may optionally operate according to different types of protocols. Non-limiting examples of parallel electronic interfaces optionally include digital or analog interfaces, such as open collector for example. More preferably, an application 44 enables such communication to occur, for example by translating, reformatting or otherwise altering messages and/or other types of data received through interface connector 40, into the proper form and structure for transmission through satellite modem 42. Satellite modem 42 then communicates with LEO satellite network 18.

According to optional but preferred embodiments of the present invention, interface connector 40 also receives communication from other components of remote ground asset 12. For example, interface connector 40 optionally and more preferably is in communication with a Canbus system (CAN bus system) 46 preferably through a serial port 97, in order to be able to communicate with components of remote ground asset 12, for example engine diagnostics 48. Canbus system 46 is known in the art as an interface and a protocol for providing a LAN (local area network) for connecting a plurality of components in different locations along a bus. Each unit communicates to all other units through broadcasting without providing a specific address. Canbus system 46 is an example of a suitable system for supporting communication with components of remote ground asset 12. This type of communication enables engine diagnostics or other tests to be performed with regard to components of remote ground asset 12. By connecting these components to the system of the present invention, the remote end user (not shown) may optionally initiate such diagnostic tests and/or receive test results, as described in greater detail below.

Panic button 32, at least one sensor 30, and at least one control 34 are all examples of hardware peripherals which could preferably be operatively associated with remote ground asset 12. Each of panic button 32, at least one sensor 30, and at least one control 34 all have an interface which can preferably communicate with interface connector 40 through input/output bus 38 which is known in the art.

The configuration and type of interface connector 40 depends on the hardware that is connected to it. Interface connector 40 is well known in the art and can be purchased as a standard component.

Interface connector 40 preferably comprises serial ports and parallel ports. Serial port 97 is shown by way of example only and is not meant to be limiting. In preferred embodiments of the present invention a text messaging module 98 may preferably be operated through a computational device for example a PDA 99 or laptop (not shown). PDA 99 may optionally and preferably be connected to interface connector 40 for text messaging. A user (not shown) can optionally use PDA 99 to communicate through serial port 97 of the interface connector bus 40 to receive and/or send data, for example in the form of e-mail messages and also optionally to send text messages via satellite modem 42.

Canbus system 46 preferably enables all hardware components in FIG. 3 to communicate with each other. Interface connector 40 does not actually enable hardware components to communicate with each other. Canbus system 46 connects to interface connector 40 and is typically used on vehicles including boats. Canbus system 46 is similar to a LAN. Canbus system 46 is a bus which enables communication with engine diagnostics 48 and at least one sensor 30, optionally for transmitting one or more commands. Interface connector 40 is also preferably connected to Canbus system 46. By way of example and without intention to be limiting, interface connector 40 is preferably connected to Canbus system 46 through serial port 97 in FIG. 3.

In preferred embodiments of the present invention, interface connector 40 may comprise a plurality of interface connectors, in which each of the plurality of interface connectors may operatively be associated with a different kind of hardware. Each of the plurality of interface connectors which comprise interface connector 40 may all preferably be in communication with Canbus system 46, which is also preferably in communication with engine diagnostics 48.

In preferred embodiments of the present invention, every piece of hardware eventually plugs into interface connector 40 and can communicate through Canbus system 46. Canbus system 46 is therefore preferably operationally similar to a LAN. It should therefore be noted that all components that communicate with Canbus system 46 communicate in bursts. All components within the system receive the burst, but only components which have been identified by a functional label or other identifier process any given message.

Canbus technology is simpler and lower cost than conventional LAN technology, such as Ethernet or Star, because Canbus technology is not concerned with addressing within the system. If a new component is added to the system, it does not need to be allocated an address.

In this example, the components as shown in FIG. 3 with the exception of the LEO satellite network 18, are part of remote ground asset 12. Canbus system 46 enables these components to exchange messages and communicate with each other. For example, if remote ground asset 12 is a boat or vehicle, then Canbus system 46 might optionally support communication between such components as the engine sensors, the chart plotter, the GPS and any other component. In preferred embodiments of the present invention, components which are connected to input/output (I/O) bus 38 may preferably communicate with each other.

Application 44 more preferably collects data and/or diagnostics from a variety of sources on remote ground asset 12, including but not limited to Canbus system 46 and at least one sensor 30. This data is then transmitted through satellite modem 42 and LEO satellite network 18 to the back office, shown as management server 96. Application 44 also preferably supports communication in the opposite direction such that the end user (not shown) is able to send one or more commands to remote ground asset 12, as described in the discussion of GUIs below.

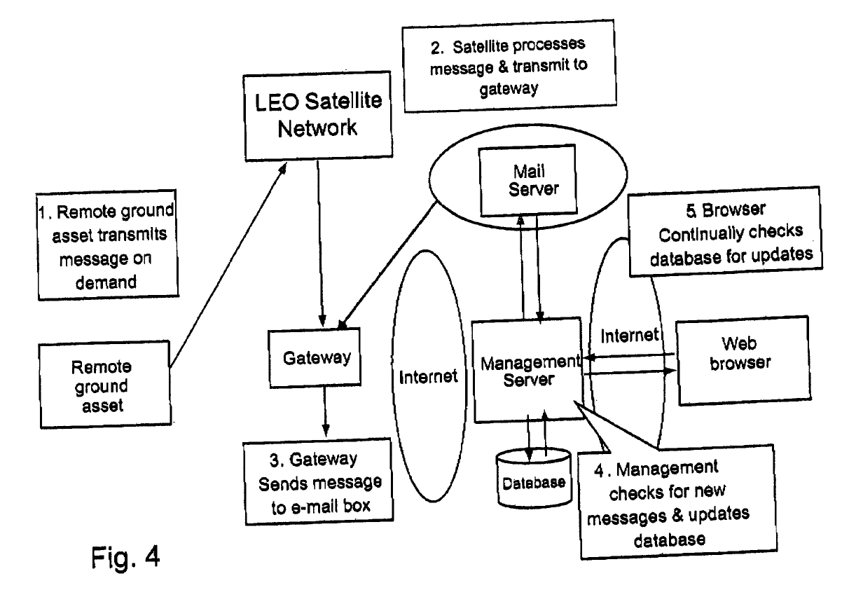

Reference is now made to FIG. 4, which illustrates an exemplary method for processing messages which are generated at the remote ground asset.

In stage 1, the remote ground asset transmits a message on demand.

In stage 2, in a preferred embodiment, the satellite processes the message and transmits the message to the gateway.

In stage 3, the mail server (at the management server) preferably pulls the message from the gateway. In another alternative embodiment, the gateway sends the message to the mail server.

In stage 4, the management server checks for new messages from the mail server, preferably continually, and updates the database accordingly.

In stage 5 the browser continually checks the database for updates and changes the GUI at the end user as necessary. Alternatively, if the Web browser is not always connected to the management server, the browser preferably checks the database for updates and changes the GUI upon connecting to the management server.

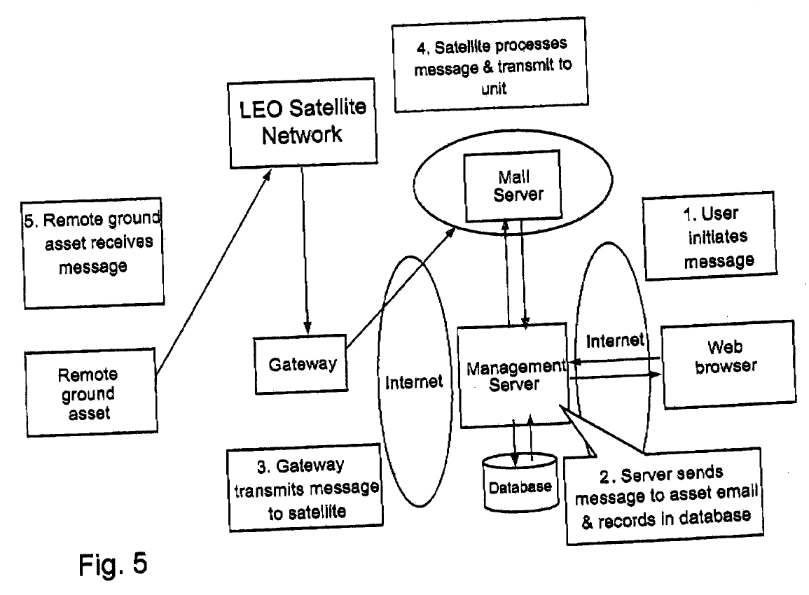

Reference is now made to FIG. 5 which illustrates an exemplary method for processing messages which are generated at the end user.

In stage 1, the end user initiates a message. In preferred embodiments of the present invention this can be done by a person through a GUI, which sends the message via the web browser through the Internet to the management server.

In stage 2, the management server sends a message to the email address operatively associated with the remote ground asset, preferably through the mail server which pushes the email message to the gateway. In preferred embodiments of the present invention, the email is preferably recorded in the database.

In stage 3, the gateway transmits the message to the satellite.

In stage 4, the satellite optionally and preferably processes the message and transmits it to the remote ground asset.

In stage 5, the remote ground asset receives the message.

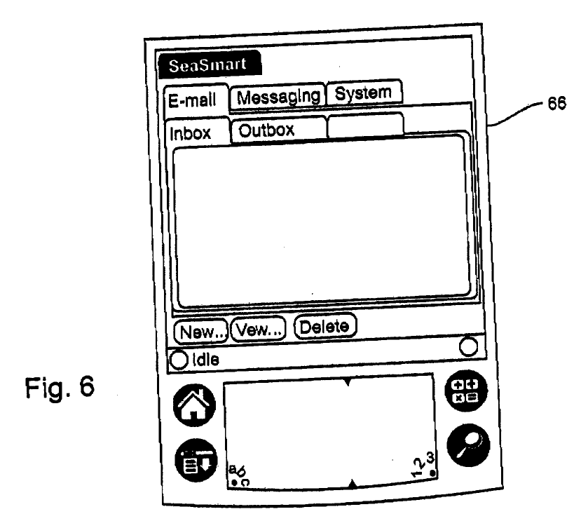

FIG. 6 shows an exemplary graphical user interface (GUI) provided to the end user demonstrating what is happening at the remote asset in an implementation of the present invention A GUI (graphical user interface) 66 according to the present invention is preferably provided as a Web page. GUI 66 demonstrates that the user at the remote asset has the ability to send and receive emails, view email folders, send and receive messages, and interact with the system embodied in the present invention.

In preferred embodiments of the present invention, the user at remote ground asset (not shown in FIG. 6) could optionally request sending or receiving (viewing received) messages from the end user. The user at the remote asset can also optionally view system information.

In certain preferred embodiments of the present invention, the user at the remote asset may preferably be able to send free text messages to a management center, such as the marina for a boat for example, and receive free text messages from the marina which may include information such as weather reports, news, messages etc.

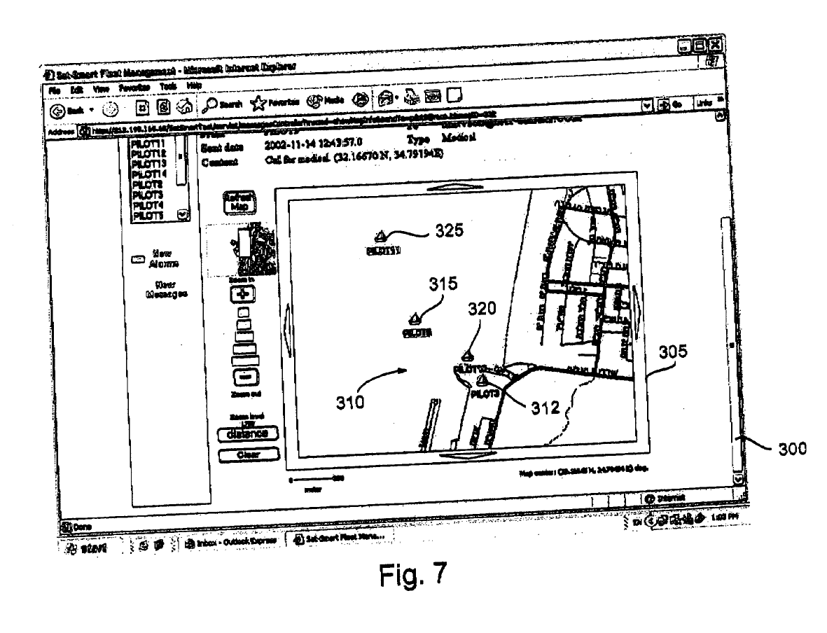

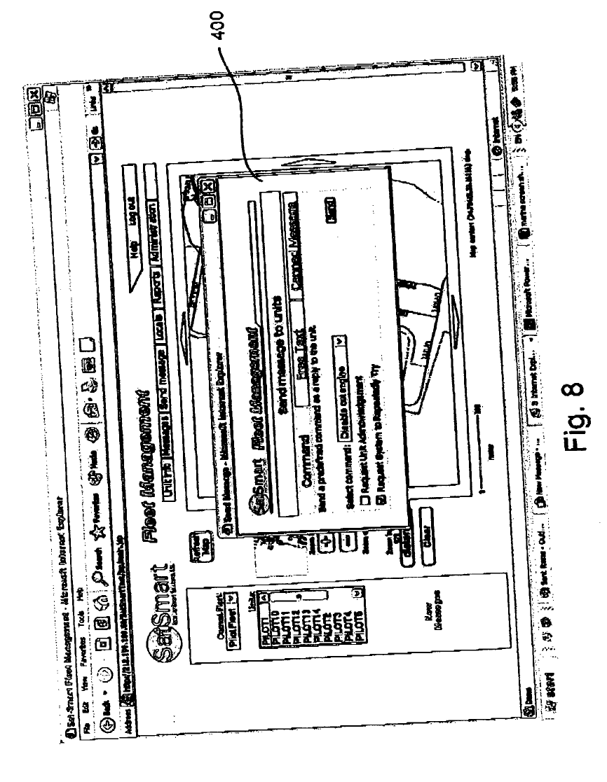

For the GUI of the end user, shown in FIGS. 7 and 8, the end user may optionally view received messages from the remote asset and/or send messages to the remote asset. The end user could also optionally request to locate the remote ground asset (not shown), for example through GPS or other location system. The end user could also optionally request to perform one or more diagnostic tests and/or send one or more commands to remote ground asset (not shown). The end user could also optionally request compilations of information in one or more predefined and/or user-defined reports Configuration of the Web pages and/or operation of the system according to the end user is also optionally performed through the GUI.

The GUI for the end user is also optionally and preferably implemented as a Web page which may optionally be accessed by the end user from a variety of locations. The end user may choose to perform a variety of actions through the GUI, both passive (receiving information about remote ground asset, which is not shown) and active (commanding the remote ground asset, which is not shown, to perform one or more actions). Therefore the GUI is both flexible and also quite powerful.

Reference is now made to FIG. 7 which shows an example of a GUI comprising a map with landmarks provided to the end user for the tracking of assets in an implementation of the present invention.

A GUI 300 comprises a map 305 with a plurality of assets 310 shown as non-limiting examples, comprising pilot3 312, pilot9 315, pilot10 320, pilot11 325.

The manager (?lot shown) can preferably be a person or an automatic control mechanism.

The manager is optionally and preferably enabled to zoom in or zoom out (of the view on (GUI 300) to better view plurality of assets 310. The manager (not shown) preferably views plurality of assets 310 in relation to landmarks on the map, which are generated by MapXtreme™ data supplied the database. The user may also optionally and preferably install landmarks on the map. In certain preferred embodiments of the present invention, the manager can trace the route on the map. The user can then check the efficiency of the routes taken and check to make sure that plurality of assets 310 are not following routes or going to destinations that are forbidden.

FIG. 8 shows an example of a GUI comprising a command sent from the end user to the remote ground asset (not shown) in an implementation of the present invention.

A manager at the end user (not shown) can use a GUI 400 to send at least one command to the remote ground asset (not shown). In the present example the manager is sending the command “disable cut engine.” This command enables the manager to disable the engine remotely.

As in FIG. 7, the manager (not shown) can preferably be a person or an automatic control mechanism. When the manager is sending a message or receiving a message, the amount of bandwidth available between the satellite (not shown) and the remote ground asset (not shown) is small.

Therefore in certain preferred embodiments of the present invention, efforts are preferably made to conserve bandwidth. There may preferably be certain preprogrammed messages or commands that for example enable the manager to select a preprogrammed command or a message. The GUI 400 may preferably be programmed to display such a command as text. She database (not shown) or web server (not shown) then translates the preprogrammed command to a number. The number is then preferably sent to the remote ground asset (not shown). The application software in the remote ground asset (not shown) then preferably translates the number which represents a preprogrammed command into a command which is then implemented or into a predetermined text message. For example the number “1” may be programmed to correspond to the text message “you are off course.”

This methodology of transmitting numbers which correspond to predetermined text messages or commands greatly reduces the amount of bandwidth used. In a preferred embodiment of the present invention an automatic mechanism may optionally and preferably be in control at the remote ground asset or at the end user. For example and without any intention of being limiting, the remote ground asset may preferably comprise an automatic sensor. For example the remote ground asset may be an oil rig which comprises a sensor which senses when the temperature starts to rise. The automatic sensor may optionally send a message through the automatic control mechanism which comprises a number which is mapped to a predetermined message such as “temperature over limit”. In a preferred embodiment of the present invention the end user may preferably send a number back to the automatic control mechanism of the remote ground asset, with the number corresponding to a predetermined command for the automatic control mechanism to perform, such as a command which activates emergency cooling procedures when the temperature at the oil rig has exceeded a predetermined threshold.

It will be appreciated that the above descriptions are intended only to serve as examples, and that many other embodiments are possible within the spirit and the scope of the present invention.

What is claimed is:

1. A system for enabling communication with a remote ground asset by an end user through a satellite, comprising:
(a) a transceiver at the remote ground asset, wherein said transceiver is capable of communication with the satellite;
(b) a gateway for communicating with said transceiver through the satellite;
(c) a management server for providing at least one Web page for said communication; and
(d) an end user device for displaying said at least one Web page to the end user.

2. The system of claim 1, further comprising a network, wherein said gateway communicates with said management server through said network.

3. The system of claim 1, further comprising a Web-based interface.

4. The system of claim 3 wherein the Web-based interface facilitates internet access.

5. The system of claim 4 wherein said Internet access supports back office services to a plurality of end users.

6. The system of claim 5 wherein the plurality of end users comprises at least one of a call center, a fleet manager, a dealer or an individual user, or a combination thereof.

7. The system of claim 4 in which the Web-based interface is implemented with a Web server.

8. The system of claim 4 wherein the Web based interface is implemented according to a Web server.

9. The system of claim 8 wherein the Web server is a node on an Internet-based infrastructure.

10. The system of claim 9 wherein the Internet-based infrastructure is the World Wide Web.

11. The system of claim 4 further comprising a back office system.

12. The system of claim 11 wherein the back office system comprises a back office server and a back office operator terminal.

13. The system of claim 12 wherein the back office operator terminal is connected to the back office server through a network connection.

14. The system of claim 1 wherein the back office system supports communication between the satellite and the end user.

15. The system of claim 14 wherein the back office system comprises an exchange server.

16. The system of claim 14 wherein the back office system comprises an SQL server.

17. The system of claim 14 whereby the back office server supports remote server administration.

18. The system of claim 14 whereby the back office server supports monitoring/troubleshooting.

19. The system of claim 14 whereby the back office server supports diagnostic views and reports.

20. The system of claim 1, further comprising a mail server, wherein said management server communicates with said gateway through said mail server.

21. The system of claim 1, wherein the satellite is part of a satellite network.

22. The system of claim 21, wherein said satellite network is in a low earth orbit.

23. The system of claim 21, wherein said satellite network is in a geosynchronous earth orbit.

24. The system of claim 1, wherein the end user is able to send a command to the remote ground asset.

25. The system of claim 24, wherein the remote ground asset further comprises at least one diagnostic component for performing a least on at least one function or component of the remote ground asset.

26. The system of claim 1, wherein said at least one Web page displays information to be end user about the remote ground asset.

27. The system of claim 1, further comprising:
(e) a GPS (global position system) device connected to the remote ground asset such that a location of the remote ground asset is provided to said gateway.

28. The system of claim 1, wherein the remote ground asset comprises a stationary object.

29. The system of claim 1, wherein the remote ground asset comprises a vehicle.

30. The system of claim 29 wherein the vehicle comprises a boat.

31. The system of claim 29 wherein the vehicle comprises an automotive vehicle.

32. The system of clam 1, wherein the remote ground asset further comprises a plurality of alarm components.

33. The system of claim 32, wherein the remote ground asset further comprises an alarm button.

34. The system of claim 32 wherein the alarm controls axe operatively associated with a mechanism for determining the location or the remote ground asset.

35. The system of claim 1, wherein the remote ground asset further comprises a power source.

36. The system of claim 1, wherein the remote ground asset further comprises a bus.

37. The system of claim 1, wherein the remote ground asset further comprises an interface connector.

38. Thc system of claim 1, wherein the remote ground asset further comprises a satellite modem.

39. The system of claim 1, wherein the remote ground asset further comprises a Canbus system.

40. The system of claim 1, wherein the remote ground asset further comprises an engine.

41. The system of claim 40, wherein the remote ground asset further comprises engine diagnostics.

42. The system of claim 1, wherein the remote ground asset further comprises a plurality of sensors.

43. The system of claim 1 further comprising a chart plotter.

44. The system of claim 1 wherein the management server comprises a communications layer.

45. The system of claim 44 wherein the communications layer comprises a plurality of hardware components.

46. The system of claim 45 wherein the hardware components comprise a modem.

47. The system of claim 45, wherein the communications layer comprises a plurality of software components.

48. The system of claim 1 wherein the management server further comprises a database for storing subscriber information.

49. The system of claim 1 wherein the subscriber information comprises identifying information.

50. The system of claim 49 wherein the identifying information comprises a password.

51. The system of claim 1, wherein said management server further comprises Geographic Information Systems (GIS) software.

52. The system of claim 51 wherein the GIS software generates one or more maps.

53. A method for enabling communication with a remote ground asset by an end user through a satellite, comprising:
receiving information through the satellite from the remote ground asset;
displaying said information to the end user as a Web-based interface;
receiving at least one command from the end user through said Web-based interface; and
transmitting said at least one command to the remote ground asset through the satellite.
